(19) United States
(12) Patent Application Publication
(10) Pub. No.: US 2014/0272566 A1
(43) Pub. Date: Sep. 18, 2014

(54) WELDABILITY OF ALUMINUM ALLOYS

(71) Applicants: Konstyantyn Kylyvnyk, Pompano Beach, FL (US); Naoki Ota, Lexington, MA (US)

(72) Inventors: Konstyantyn Kylyvnyk, Pompano Beach, FL (US); Naoki Ota, Lexington, MA (US)

(21) Appl. No.: 14/251,638

(22) Filed: Apr. 13, 2014

Related U.S. Application Data
(63) Continuation of application No. 13/549,152, filed on Jul. 13, 2012, now abandoned.

(51) Int. Cl. H01M 4/64; H01M 10/0525; H01M 4/66

(52) U.S. Cl. CPC H01M 4/64; H01M 4/661; H01M 10/0525
USPC 429/211

(57) ABSTRACT

A method is provided for modifying a surface of a first, relatively difficult-to-weld metal substrate in preparation for a subsequent joining method by applying a thin layer of a second, relatively easy-to-weld metal to the surface of the first metal substrate.

### CROSS REFERENCE TO RELATED APPLICATION

This application is a continuation application that claims priority to U.S. Non-provisional application Ser. No. 13/549,152, filed on Jul. 13, 2012, which claims the benefit of U.S. Provisional Patent Application Ser. No. 61/507,445, filed on Jul. 13, 2011, the disclosure of which is hereby expressly incorporated by reference herein in its entirety

### FIELD OF THE DISCLOSURE

This disclosure relates generally to the field of material joining technology as it relates to welding aluminum (Al), Al alloys, and other difficult-to-weld metals. Specifically, this disclosure relates to a method for improving weld conditions and strength in the weld zone. In particular, this disclosure relates to the field of welding of current collector tabs and connectors (i.e., leads) of power sources, such as batteries.

### BACKGROUND OF THE DISCLOSURE

A growing application for Al and Al alloys are as current collectors. Such current collectors may be used in power sources related to Li-ion batteries and in other applications, for example.

Al and Al alloys are very difficult to weld, because aluminum oxide (Al₂O₃), also known as alumina, tends to grow on the surface of the metal. The aluminum oxide must be removed from the surface, preferably immediately prior to welding. Al alloys are available in heat-treatable and non-heat-treatable forms. Heat-treatable Al alloys get their strength from a process called aging. However, a significant decrease in tensile strength can occur when welding Al due to over-aging.

Currently, ultrasonic welding is used for welding Al alloy current collectors after assembling batteries. However, ultrasonic welding subjects the batteries' current collectors to high-frequency ultrasonic acoustic vibrations, which may negatively impact porous electrode structures of the batteries and cause defoliation of active masses inside the batteries.

Spot resistance welding may also be used for welding Al alloy current collectors. However, spot resistance welding Al alloys presents significant problems related to metal transfer from welding electrode tips, low strength of resulting welds, and excessive contact resistance.

Various attempts have been made to improve spot welding, brazing, and soldering of Al alloys. Nonetheless, to date, there still remains a strong need for a reliable solution for welding Al alloys and similar difficult-to-weld metals.

### SUMMARY

This disclosure is directed to a method of modifying a surface of a first, relatively difficult-to-weld metal substrate in preparation for a subsequent joining method by applying a thin layer of a second, relatively easy-to-weld metal to the surface of the first metal substrate. The second metal layer may have superior weldability characteristics over the first metal substrate. In an exemplary embodiment, the second metal layer is applied to the underlying, first metal substrate via a cold deposition process. Typically, applications with a cold deposition process result in embedding the applied second metal layer with local fusion into the first metal substrate.

Modifying the first metal substrate according to the present method may provide flexibility in selecting the type of subsequent joining method to be used. Suitable joining methods may include resistance welding, thermo welding, brazing, or soldering, for example. Additionally, by improving the weldability characteristics of the first metal substrate, the present method may improve the outcome of the subsequent joining method, such as by improving weld conditions and strength in the weld zone.

According to an exemplary embodiment of the present disclosure, an electrochemical cell is provided including an electrode having an active layer, a conductive layer, and a metal coating layer on the conductive layer, and an electrical connector in electrical communication with the conductive layer via the metal coating layer, the electrical connector being welded to the metal coating layer to improve weldability of the electrical connector to the electrode.

According to another exemplary embodiment of the present disclosure, a method is provided for modifying a substrate metal surface in preparation of a joining method by applying thin layer of metal with good weldability to the substrate metal surface.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is a schematic view of an exemplary battery cell of the present disclosure, the cell including a first electrode, a second electrode, and an electrical line that electrically couples the first and second electrodes;

FIG. 2 is a schematic view of an electrode of FIG. 1, the electrode further including an intermediate metal layer between a current collector of the electrode and a lead of the electrical line;

FIG. 3 is a schematic view of an exemplary cold deposition apparatus for forming the intermediate metal layer of FIG. 2;

FIG. 4 includes photographs showing Al foil substrates with Cu coating layers;

FIG. 5A is a photograph similar to FIG. 4, further showing an electrical lead soldered to the Cu coating layer;

FIG. 5B is a photograph similar to FIG. 5A, showing an electrical lead soldered to a bronze coating layer;

FIG. 6 shows spectral analysis results for a fractured Cu-coated sample; and

FIG. 7 shows spectral analysis results for a fractured bronze-coated sample.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

A battery cell 100 is illustrated schematically in FIG. 1. Cell 100 may be in the form of a lithium (Li) ion cell. Cell 100 may be used in secondary (rechargeable) or non-rechargeable batteries. Cell 100 may be used in a rechargeable battery of a hybrid vehicle or an electric vehicle, for example, serving as a power source that drives an electric motor of the vehicle. Cell 100 may also store and provide energy to other devices which receive power from batteries, such as the stationary energy storage market. Exemplary applications for the stationary energy storage market include providing power to a power grid, providing power as an uninterrupted power supply, and other loads which may utilize a stationary power source. In one embodiment, cell 100 may be implemented to provide an uninterrupted power supply for computing devices and other equipment in data centers. A controller of the data center or other load may switch from a main power source to an energy storage system of the present disclosure based on one or more characteristics of the power being received from the main power source or a lack of sufficient power from the main power source.

Cell 100 of FIG. 1 includes a negative electrode (or anode) 112 and a positive electrode (or cathode) 114. Between negative electrode 112 and positive electrode 114, cell 100 of FIG. 1 also contains an electrolyte 116 and, optionally, a separator 118. When discharging cell 100, Li-ions travel through electrolyte 116 from negative electrode 112 to positive electrode 114, with electrons flowing externally through line 120 in the same direction from negative electrode 112 to positive electrode 114 and current flowing in the opposite direction from positive electrode 114 to negative electrode 112, according to conventional current flow terminology. When charging cell 100, an external power source forces reversal of the current flow from negative electrode 112 to positive electrode 114 via line 120.

Negative electrode 112 of cell 100 illustratively includes a first layer 112a of an active material that interacts with Li-ions in electrolyte 116 and an underlying substrate or second layer 112b of a conductive material, as shown in FIG. 1. The first, active layer 112a may be applied to one or both sides of the second by adhering, depositing, or otherwise affixing first layer 112a to second layer 112b. The active material in the first layer 112a of negative electrode 112 should be capable of reversibly storing Li species. Exemplary active materials for the first layer 112a of negative electrode 112 include lithium metal oxide (e.g., LiTiO), metal (e.g., Sn, Si), metal oxide (e.g., SnO, SiO), carbon (e.g., graphite, hard carbon, soft carbon, carbon fiber), and combinations thereof, for example. The second, conductive layer 112b of negative electrode 112 may be in the form of a thin foil sheet or a mesh, for example.

Positive electrode 114 of cell 100 illustratively includes a first layer 114a of an active material that interacts with Li-ions in electrolyte 116 and an underlying substrate or second layer 114b of a conductive material. Like the first, active layer 112a of negative electrode 112, the first, active layer 114a of positive electrode 114 may be applied to one or both sides of the second, conductive layer 114b by adhering, depositing, or otherwise affixing first layer 114a to second layer 114b. The active material in the first layer 114a of positive electrode 114 should be capable of reversibly storing lithium species. Exemplary active materials for the first layer 114a of positive electrode 114 include lithiated transition metal oxides (e.g., LiMn₂O₄ (LMO), LiCoO₂ (LCO), LiNiO₂, LiFePO₄, LiNiCoMnO₂), combinations thereof, and their solid solutions, for example. The active materials may be combined with other metal oxides and dopant elements (e.g., titanium, magnesium, aluminum, boron, cobalt, nickel, manganese). The second, conductive layer 114b of positive electrode 114 may be in the form of a thin foil sheet or a mesh, for example.

As shown in FIG. 1, negative electrode 112 and positive electrode 114 of cell 100 are plate-shaped structures. It is also within the scope of the present disclosure that negative electrode 112 and positive electrode 114 of cell 100 may be provided in other shapes or configurations, such as coiled configurations. It is further within the scope of the present disclosure that multiple negative electrodes 112 and positive electrodes 114 may be arranged together in a stacked configuration.

Electrolyte 116 of cell 100 illustratively includes a lithium salt dissolved in an organic, non-aqueous solvent. The solvent of electrolyte 116 may be in a liquid state, in a solid state, or in a gel form between the liquid and solid states. Suitable liquid solvents for use as electrolyte 116 include, for example, cyclic carbonates (e.g. propylene carbonate (PC), ethylene carbonate (EC)), alkyl carbonates, dialkyl carbonates (e.g., dimethyl carbonate (DMC), diethyl carbonate (DEC), ethyl methyl carbonate (EMC)), cyclic ethers, cyclic esters, glymes, lactones, formates, esters, sulfones, nitrates, oxazoladinones, ionic liquids, and combinations thereof. Suitable solid solvents for use as electrolyte 116 include, for example, polyethylene oxide (PEO), polyacrylonitrile (PAN), polymethylene-polyethylene oxide (MPEO), polyvinylidene fluoride (PVDF), polyphosphazenes (PPE), and combinations thereof. Suitable lithium salts for use in electrolyte 116 include, for example, LiPF₆, LiClO₄, LiSCN, LiAlCl₄, LiBF₄, LiN(CF₃SO₂)₂, LiCF₃SO₃, LiC(SO₂CF₃)₃, LiO₃SCF₂CF₃, LiC₆F₅SO₃, LiCF₃CO₂, LiAsF₆, LiSbF₆, and combinations thereof. Electrolyte 116 may comprise various combinations of the materials exemplified herein.

Separator 118 of cell 100, if provided, may be positioned between negative electrode 112 and positive electrode 114. Separator 118 is illustratively a porous or microporous, thin film membrane made from a polymeric material (e.g., polyolefin, polyethylene, polypropylene) or a ceramic material, for example. Separator 118 may act as an electrical insulator between negative electrode 112 and positive electrode 114 to prevent cell 100 from short circuiting.

As shown in FIG. 1, line 120 electrically couples negative electrode 112 to positive electrode 114. More specifically, line 120 electrically couples the second, conductive layer 112b of negative electrode 112 to the second, conductive layer 114b of positive electrode 114. In FIG. 1, line 120 includes a first lead 122 that is electrically coupled to conductive layer 112b of negative electrode 112 and a second lead 124 that is electrically coupled to conductive layer 114b of positive electrode 114. Leads 122, 124 may be electrically coupled to conductive layers 112b, 114b of electrodes 112, 114 by resistance welding, thermo welding, brazing, soldering, or another suitable joining method, for example. Exemplary conductive materials for second layers 112b, 114b of electrodes 112, 114 include Al and Al alloys. It is also within the scope of the present disclosure that conductive layers 112b, 114b of electrodes 112, 114 may be constructed of copper, nickel, titanium, stainless steel, and alloys thereof, for example.

A method is provided to improve the bond between conductive layer 112b and its corresponding lead 122 and/or conductive layer 114b and its corresponding lead 124. The method involves modifying a surface 132 of one or both conductive layers 112b, 114b by applying a thin metal layer 130 to the surface 132, as shown schematically in FIG. 2. The method is illustrated and described further below with conductive layer 114b as the substrate that receives metal layer 130, but it is understood that the method may also be performed with conductive layer 112b as the substrate.

Referring still to FIG. 2, metal layer 130 is applied to surface 132 of substrate 114b such that, when substrate 114b is coupled to its corresponding lead 124, metal layer 130 is located between substrate 114b and lead 124. Metal layer 130 need not cover the entire surface 132 of substrate 114b. For example, metal layer 130 may be in the shape of a discrete dot or a discrete band on surface 132 of substrate 114b.

Metal layer 130 is illustratively thinner than substrate 114b. In certain embodiments, metal layer 130 may have a thickness of at least about 20 μm, for example, with the thickness of substrate 114b exceeding 20 μm. In other embodiments, metal layer 130 and substrate 114b, together, may have a thickness of at least about 20 μm. However, it is within the scope of the present disclosure that the thickness of metal layer 130 and substrate 114b may vary.

According to an exemplary embodiment of the present disclosure, metal layer 130 is applied to surface 132 of substrate 114b via a cold deposition process. An exemplary cold deposition apparatus 300 is shown in FIG. 3. Although apparatus 300 is described herein for performing the cold deposition process, other equipment capable of accelerating dry metal particles toward a substrate may be used.

Apparatus 300 illustratively includes controller 302, which may be a general purpose computer. Controller 302 may access certain process parameters from memory and/or from a user input (e.g., a keyboard). In an exemplary embodiment of the present disclosure, the user inputs information regarding the substrate 114b and the desired characteristics of the applied metal layer 130, and controller 302 automatically generates the necessary process control parameters.

Apparatus 300 also includes housing 304 that houses substrate 114b. Specifically, substrate 114b is shown mounted onto support 306 inside housing 304 of apparatus 300. Support 306 is provided to hold substrate 114b tightly in place and support substrate 114b during the coating process. The illustrated support 306 is shaped as a flat plate to receive a similarly shaped substrate 114b. If substrate 114b were provided on a continuous roll, instead of as an individual piece of foil, for example, support 306 could be shaped as a roller to hold and unroll substrate 114b.

Apparatus 300 further includes mill 310 (e.g., a ball mill, a jet mill) containing metal powder particles that will be used to form metal layer 130. The metal powder particles may have a diameter of about 0.5 μm to about 10 μm, for example. The metal powder particles may be present in mill 310 at ambient temperature, for example. Apparatus 300 also includes feeder 312 to deliver a measured amount of the powder particles. The operation of mill 310 and feeder 312 may be controlled by controller 302.

Apparatus 300 further includes pressure tank 314 for supplying a pressurized carrier gas and heater 316 for heating the pressurized carrier gas. The carrier gas may be heated to a temperature between about 100° C. and about 500° C., for example. The operation of pressure tank 314 and heater 316 may be controlled by controller 302. The carrier gas from tank 314 and heater 316 encounters the powder particles from mill 310 and feeder 312 in nozzle 318 to form a powder-gas mixture. Although the carrier gas may be heated, the carrier gas may not be heated to a temperature high enough to melt the powder particles. Thus, the powder particles may remain in a solid state while suspended in the carrier gas.

From nozzle 318, the powder-gas mixture may be accelerated toward substrate 114b at high speed to form metal layer 130 on substrate 114b. In addition to forming metal layer 130 atop surface 132 of substrate 114b, some metal powder may become embedded into substrate 114b beneath surface 132. To achieve maximal adhesion to substrate 114b, the powder-gas mixture may be directed toward substrate 114b at a speed from about 50 m/s to about 500 m/s, for example. Nozzle 318 of FIG. 3 is illustratively in the form of a de Laval nozzle that is mounted on a robotic arm 320 for moving nozzle 318 in housing 304 relative to substrate 114b. The operation of nozzle 318 and arm 320 may be controlled by controller 302. In an exemplary embodiment, nozzle 318 is arranged at an angle relative to surface 132 of substrate 114b between about 85° and about 95°, and more specifically about 90°. In other words, nozzle 318 may be substantially perpendicular to surface 132 of substrate 114b.

Apparatus 300 may still further include an exhaust 322 and a solid-gas separator 324. An exemplary separator 324 includes a cyclone. Excess powder-gas mixture that is not applied to substrate 114b may travel through exhaust 322 to separator 324. The separated coating powder may be returned to mill 310 for reuse, and the separated carrier gas may be vented from the system or returned to pressure tank 314 for reuse.

According to an exemplary embodiment of the present disclosure, metal layer 130 comprises a metal having good weldability characteristics. More specifically, metal layer 130 may have superior weldability characteristics over substrate 114b, with metal layer 130 being a relatively easy-to-weld metal and substrate 114b being a relatively difficult-to-weld metal (e.g., Al or an Al alloy). Metal layer 130 may also comprise a metal that is suitable for application to substrate 114b using a cold deposition process, as discussed above. Exemplary metals and metal alloys for use in metal layer 130 include, for example, copper (Cu), tin (Sn), lead (Pb), magnesium (Mg), bronze, brass, tin-lead (Sn—Pb), tin-zinc (Sn—Zn), tin-antimony (Sn—Sb), Bi, and combinations thereof.

Returning to FIG. 2, after metal layer 130 is applied to substrate 114b, such as via the above-described cold deposition process, the corresponding lead 124 may be coupled to metal layer 130. The improved weldability of metal layer 130 versus substrate 114b may provide flexibility in selecting the type of joining method to be used to couple lead 124 to metal layer 130. Suitable joining methods include resistance welding, thermo welding, brazing, or soldering, for example. Previously, without metal layer 130 in place to improve the weldability of substrate 114b, such joining methods may not have produced an adequately strong weld zone or bond between lead 124 and substrate 114b. Also, without metal layer 130 in place, substrate 114b may have been subjected to over-aging. Thus, the presence of metal layer 130 may preserve the tensile strength of substrate 114b and may strengthen the overall coupling between substrate 114b, metal layer 130, and lead 124. Joining methods that could negatively impact substrate 114b, such as ultrasonic welding, may be avoided. Lead 124 may be coupled to metal layer 130 before or after assembling battery 100 (FIG. 1).

### EXAMPLES

Substrates of 100 μm thick Al foil were coated with thin layers of Cu (FIG. 4) and bronze, as discussed above. Electrical leads were then soldered to the Cu-coated samples (FIG. 5A) and the bronze-coated samples (FIG. 5B), respectively. The soldering process was easy to perform and produced good adhesion between the leads and the corresponding samples.

The samples were fractured and subjected to spectral analysis. FIG. 6 shows a Cu-coated sample, with a relatively thin layer of Cu being deposited atop the Al foil substrate. FIG. 7 shows a bronze-coated sample, the bronze layer being cold-deposited onto the Al substrate to form a surface layer on the Al substrate, and also embedding into the Al substrate.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. An electrochemical cell comprising;
an anode presenting a conductive layer defining a first surface, an active layer extending from said conductive layer, said conductive layer extending beyond said active layer of said anode,
a cathode presenting a conductive layer defining a second surface, an active layer extending from said conductive layer of said cathode, said conductive layer of said cathode extending beyond said active layer of said cathode,
a separator extending between said cathode and said anode;
a line electrically couples said cathode and said anode through a first lead and a second lead extending between said line and said cathode and said anode; and
a pair of metal layers connected to each of said conductive layers of said cathode and said anode and extending between said conductive layers of said cathode and said anode and said first lead and said second lead extending between said line and said cathode and said anode with each of said metal layers is connected to each of said conductive layers of said cathode and said anode through a cold deposition whereby each of said metal layers is formed from metal powder particles forming said metal layers with some of said metal powder particles embedded into each of said conductive layers of said anode and said cathode extending beyond said first surface of said anode and said second surface of said cathode.

22. The electrochemical cell as set forth in claim 21, wherein said conductive layer comprises an aluminum or an aluminum alloy.

23. The electrochemical cell as set forth in claim 21, wherein each said metal layer has a thickness of at least 20 nm and at least 20 microns.

24. The electrochemical cell as set forth in claim 21, wherein each said metal layer has at least one of a circular configuration and a non-circular configuration.

25. The electrochemical cell as set forth in claim 21, wherein each said metal layer is selected from a group of metals and metal alloys consisting of a copper, a tin, a lead, a magnesium, a bronze, a brass, a tin-zinc, a tin-antimony, a Bi, and combination thereof.
